(19) United States
(12) Patent Application Publication
(10) Pub. No.: US 2021/0212283 A1
(43) Pub. Date: Jul. 15, 2021

(54) FEED COMPONENT APPORTIONMENT SYSTEM FOR FEEDING LIVESTOCK

(71) Applicant: Provender Technologies, LLC, Dimock, SD (US)

(72) Inventor: Henry Wegehaupt, Dimock, SD (US)

(73) Assignee: Provender Technologies, LLC, Dimock, SD (US)

(21) Appl. No.: 17/144,367

(22) Filed: Jan. 8, 2021

Related U.S. Application Data
(60) Provisional application No. 62/958,821, filed on Jan. 9, 2020.

(51) Int. Cl. A01K 5/00; A01K 5/02

(52) U.S. Cl. CPC A01K 5/007; A01K 5/0208; A01K 5/0275

(57) ABSTRACT

A feed component apportionment system for feeding livestock is disclosed. The system may include feed sources configured for dispensing feed components during a dispensing operation. At least one feed handling system is operatively configured for receiving feed components from the feed sources and moving the feed components using a feed displacer. The feed handling system is configured to apportion each feed component along at least one of the one or more feed displacers during a feed handling operation. At least one feed component aggregator is operatively configured to receive each of the feed components from the feed sources and provide an aggregated output of the feed sources during a feed component aggregator operation. At least one controller is operatively configured to control the dispensing operation, the feed handling operation, and the feed component aggregator operation.

### CROSS-REFERENCE TO RELATED APPLICATIONS

This application claims priority under 35 U.S.C. § 119 to provisional application Ser. No. 62/958,821 filed Jan. 9, 2020, which is incorporated by reference in its entirety.

### FIELD OF THE DISCLOSURE

The present disclosure relates to a livestock feed component apportionment system or automated livestock feeding system used in the agricultural industry. More particularly, but not exclusively, the present disclosure relates to an automated livestock feeding system which provides precise control of the quantity, position, and overall apportionment of each feed component, and therefore the exact mix of feed components, used in preparation of a feed recipe for a livestock feeding process.

### BACKGROUND

Automatic feeding systems in which feed components are fetched from storage devices or feed kitchens, mixed in the prescribed manner, and distributed to animals are well-known. For example, the Trioliet Triomatic, Lely Vector, DeLaval Optimat, and KUHN System TKS all operate on this basis. Each of the named systems utilizes means of conveyance or a grabber to transfer different feed varieties from storage devices or a feed kitchen into a mixer which mixes the feed to create a feed recipe. The mixer may be a stand-alone, stationary device or part of feed delivery.

Consistency in nutrient and dry matter intake is critically important to optimal cattle performance. Variation in dry matter or nutrient intake greatly reduces feed efficiency, reduces milk production, and affects animal health, which ultimately increases costs and decreases revenue. It is a common practice to feed cattle a total mixed ration (TMR), for example, a mixture of forages, grains, proteins, supplements, byproducts, vitamins, minerals, sometimes medicated feed additives, and other suitable feed ingredients. Therefore, a need to optimize performance has been identified, on in which these, and other, feed components must be delivered to each animal in a group in a defined and consistent manner.

Creating a uniformly mixed total mixed ration (TMR) is an unsolved problem with commercially available TMR mixers that are used in automatic/autonomous, semi-automatic/semi-autonomous, and manual feeding processes. The different physical properties of the feed components included in a total mixed ration diet make it difficult to obtain a uniform mixture, especially using the simple auger design of many batch mixers. For example, heavy feed components sink to the bottom of the mixer, lighter feed components float, and dry feed components of small particle size stick to high-moisture feed components, such as silage or molasses. Additionally, over or under-filling a mixer results in an inconsistent and improperly mixed ration. Moreover, mixing feed components for an inadequate or extended period of time results in an improper mix or over-processed feed components. Further challenges arise when dispensing feed from a TMR mixer to a feeding area. Discharging and distributing feed along a feeding area is not a tightly controlled and metered process given the uncertain movement of feed within the mixing chamber to the discharge door, and the use of large discharge doors and discharge units to allow for feed to exit the mixing chamber and to be quickly distributed to the feeding area. Therefore, a need has been identified for a system that precisely and accurately controls the quantity, position and overall apportionment of each feed component making up the feed recipe throughout an entire feeding process.

Conventional approaches for creating feed mixtures is generally done by batch mixing where all feed components of a feed recipe are loaded into a mixer in their respective amounts and mixed. Thus, for example, a batch mixer disperses disparate feed components throughout the mixer (macro mixing) and then divides them into a uniform mass (micro mixing). Therefore, a need has been identified to provide a system wherein the feed components making up a feed recipe are all correctly proportioned one to the other before they are inserted into an aggregation system and mixed in a continuous flow or mixed as a predefined apportionment along a length of a container. Feed components can be correctly proportioned one to the other, for example, by metering and dosing feed components from ingredient feeders, such as volumetric or gravimetric feeders, or by apportioning feed components in a predefined manner along a portion or entirety of a controlled feed displacer, such as a conveyor, or by apportioning feed components in a predefined manner along a proportional length or the entire length of a feed displacer or feed delivery system, such as an elongated mixing container mounted on a feed delivery device.

### SUMMARY

It is to be understood that both the foregoing general description and the following detailed description are exemplary and explanatory only and are not necessarily restrictive of the disclosure as claimed. The accompanying drawings, which are incorporated in and constitute a part of the specification, illustrate embodiments of the disclosure and together with the general description, serve to explain the principles of the disclosure.

Therefore, it is a primary object, feature, or advantage of the present disclosure to improve over the state of the art.

It is a further object, feature, or advantage of the present disclosure to address the deficiencies with how conventional automated or semiautomated feeding systems operate and process feed components to provide a mixed ration.

It is a still further object, feature, or advantage of the present disclosure to provide a system wherein feed components are delivered to each animal in a group in a defined and consistent manner.

Another object, feature, or advantage is to provide a system that precisely and accurately controls the quantity, position and overall apportionment of each feed component making up a feed recipe.

Yet another object, feature, or advantage is to provide a system wherein two or more or a plurality of feed components are all correctly proportioned, each one relative to the other, before they are inserted into an aggregation system and mixed in a continuous flow, mixed as a predefined apportionment along a length of a container, or delivered as a predefined apportionment of two or more or a plurality of feed components. Feed components can be correctly proportioned one to the other, for example, by metering and dosing feed components from ingredient feeders, such as volumetric or gravimetric feeders, or by apportioning feed components in a predefined manner along a controlled feed displacer, such as a conveyor or other suitable feed apportionment displacer, or by apportioning feed components in a predefined manner along a length of a feed displacer, such as an elongated mixing container mounted on a feed delivery device.

In one aspect, the disclosure includes the configuration of one or more systems used individually, or in any combination. Systems of the present disclosure can include, for example, a feed handling system for supplying a controlled insertion or apportionment of each feed component from a feed source to the feed displacement system; a feed displacement system for receiving each feed component from the feed handling system, displacing it in a controlled manner, and apportioning it along the feed delivery system in a controlled manner a feed delivery system for transporting the feed components to the feeding area; a feed dispensing system for dispensing the feed from the feed delivery system to the feeding area in a controlled manner; a feed aggregation system for mixing feed components in a controlled manner; and a control system for controlling each individual system making up the automated livestock feeding system thus controlling the feeding process.

One or more of these and/or other objects, features, or advantages of the present disclosure will become apparent from the specification and claims that follow. No single embodiment need provide each and every object, feature, or advantage. Different embodiments may have different objects, features, or advantages. Therefore, the present disclosure is not to be limited to or by an objects, features, or advantages stated herein.

### BRIEF DESCRIPTION OF THE DRAWINGS

The disclosure will now be described in greater detail on the basis of non-limiting illustrative embodiments, as well as the drawing and description thereof, in which:

FIG. 1 is a block diagram of an automated livestock feeding system in accordance with an illustrative aspect of the present disclosure;

FIG. 2 provides a pictorial representation of an automated livestock feeding system in accordance with an illustrative aspect of the present disclosure;

FIG. 3 provides another pictorial representation of an automated livestock feeding system in accordance with an illustrative aspect of the present disclosure;

FIG. 4 provides another pictorial representation of an automated livestock feeding system in accordance with an illustrative aspect of the present disclosure; and

FIG. 5 provides another pictorial representation of an automated livestock feeding system in accordance with an illustrative aspect of the present disclosure.

### DETAILED DESCRIPTION

Illustrative aspects of a livestock feed component apportionment system or automated livestock feeding system are designated by the reference numeral 10. For brevity and no intention to be limiting, the livestock component apportionment optimizer or automated livestock feeding system 10 of the present disclosure will be referred to hereafter as automated feeding system 10. The automated feeding system 10 is configured to provide precise control of the quantity, position, and overall apportionment of each feed component in a livestock feeding process. A feed component can be any type of ingredient, compound, formula, compositional makeup, and the like.

After reading this description, it will become apparent to one skilled in the art how to implement the disclosure in various alternative aspects and in alternative applications. However, although various aspects of the present disclosure will be described herein, it is understood that these aspects are presented by way of example only, and not for the purpose of limitation. As such, the detailed description of the various alternative aspects should not be construed to limit the scope or breadth of the present disclosure as set forth in the following description and concluded in the appended claims.

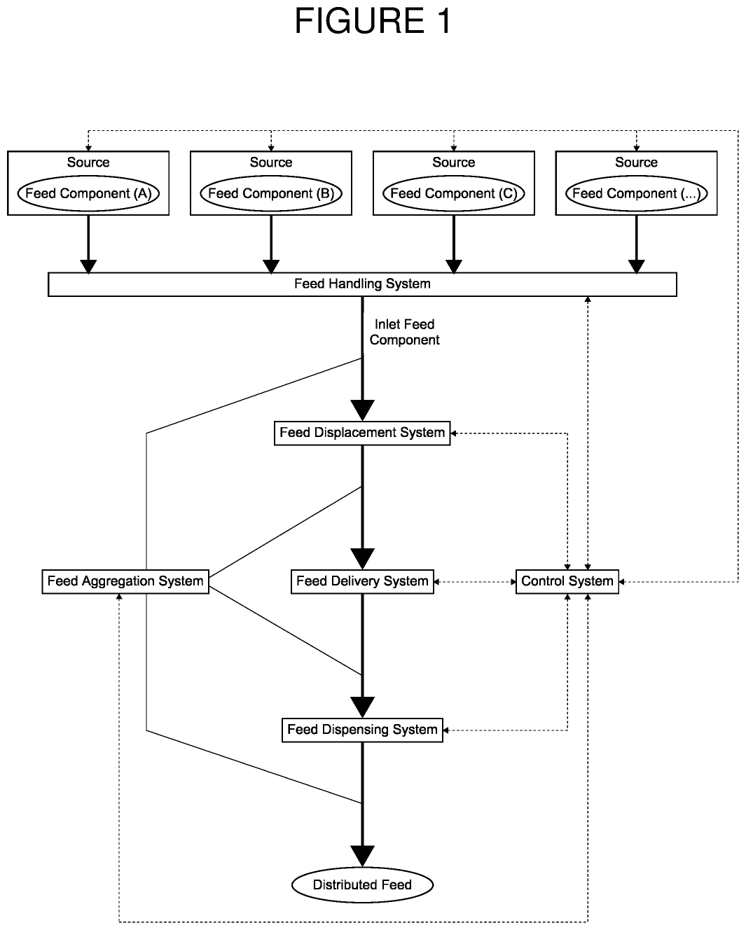

FIGS. 1 to 5 provide pictorial representations for various illustrative aspects of an automated feeding system 10. The automated feeding system 10, includes for example, one or more systems, subsystems, and processes. Two or more systems of the present disclosure may be operatively configured to provide a system, subsystem or process achieving the one or more objects, features or advantages of the present disclosure. All systems, subsystems, and processes of the disclosure are not required together to achieve at least or any one object, feature and advantage of the present disclosure. In accordance with at least one aspect of the disclosure, the automated feeding system 10 can include one or more of the following systems, subsystems, or processes. For example, the automated feeding system 10 can include a feed handling system 12, a feed displacement system 13, a feed delivery system 14, a feed dispensing system 15, a feed aggregation system 16, and a control system 17. Systems may be formed separately of one another, or the systems may be operably connected, or a single system may perform the function of two or more systems. The systems are preferably operably configured in proximity to each other on a flat, nearly flat, or finished surface 18. Alternatively, mounting and installation hardware may be used to operably configure the livestock feeding system 10 across changes in elevation, whether due to topography or installation parameters.

The automated feeding system 10 is operably configured to make use of feed sources 24 containing different feed components. Feed components can include, but are not limited to, forages, grains, proteins, supplements, byproducts, vitamins, minerals, sometimes medicated feed additives, and other suitable feed components. The prescribed quantities and apportionment of one or more feed components form a feed recipe. The term feed recipe is used throughout and is not intended to be limiting. For example, feed recipe can include, but is not limited to, a total mixed ration, mixed ration, a feed order, or the like. A feed recipe can be an operator-defined feature of the control system 17. Pre-set or customizable feed recipes can also be a feature of the control system 17. An operator interface of or operably configured to the control system 17, as addressed hereafter, is operably configured to receive operator input for controlling operation of the automated feeding system 10. A feed recipe of this type can be composed with the automated feeding system 10, so as subsequently to be fed to a group of animals, such as dairy or beef cattle. To this end, the control system 17 contains or generates, and is customizable or preconfigurable, for individual animals or one or more different groups of animals, one or more associated feed recipes. If so prescribed, these feed recipes can be generated, for example, using a computer 19 in an office 20 or from a mobile device 21. The illustrated connection of the control system 17 to the computer 19 and the mobile device 21, as well as to the automated feeding system, can both be enable using a wired network 22 and/or a wireless network 23.

A pictorial representation of an electronic control system 17 for controlling the automated feeding system 10 is illustrated in FIG. 1 and herein throughout. The control system 17, directly or indirectly, controls each individual system, subsystem, or process, such as, for example systems 12-16, making up the automated feeding system 10 and controls operation of the feeding process. The control system 17 may receive, process, and use feedback from each individual system, for example, to control the feeding process and to display and store information related to any one of the system 12-16 operations, including data logging the particulars for any system operations, operator-controlled operations, and all with accompanying timestamps. The control system 17 is operably configured for an operator 25 to communicate with the control system 17 such as via a computer 19 or mobile device 21, or via other network, Bluetooth, Wi-Fi, or cellular enabled devices.

TABLE 1
Feed Recipe

| Ingredient | % of Total Mixed Ration, Dry Matter Basis |
|---|---|
| Corn silage | 26.8 |
| Alfalfa silage | 13.1 |
| Whole cottonseed | 17.9 |
| Soybean hulls | 9.2 |
| Corn gluten feed | 8.8 |
| Bypass blend* | 4.5 |
| Corn grain, ground | 15.8 |
| 48% Soybean meal | 1.3 |
| Calcitic limestone | 0.57 |
| Salt | 0.46 |
| Sodium bicarbonate | 0.75 |
| Bentonite** | 0.67 |
| Vitamin TM premix | 0.12 |
| Potassium carbonate | 0.03 |

*Blend of poultry by-product meal, hydrolysed poultry feathers, meat and bone meal, blood meal, and fish meal (Nutrimax Inc., Greensboro NC, USA)
**Volclay © (American colloid Co., Arlington Heights IL, USA)

The control system 17 may be programmed such that, one or multiple times each day, a predetermined feed recipe of which an example is shown in Table 1, above, is composed and distributed to a feeding area, where intervention is only required on part of the operator 25 to refill feed sources 24 when necessary. Alerts may be sent to the operator 25, for example, in event of a system error and to alert the operator 25 of low quantities of feed remaining in any one feed source 24.

The feed handling system 12 is operably connected to the feed source 24 and supplies a controlled introduction of a feed component from the feed source 24 to the feed displacement system 13. By feed source 24 it is meant to include any feed input to the automated feeding system 10, wherein the “any feed input” is a feed component. For example, a feed source can include, but is not limited to, a device which both contains and stores a single feed component or multiple feed components temporarily or over an extended period of time, all parameters of which can be logged by control system 17. A plurality of feed sources 24 may be used to store different feed components. Such feed sources 24 can be, for example, buffer tables, hopper bottom bins, buildings, bunkers, tower silos, bag silos, containers, wagons, trailers, and the like. A specific feed source 24 can be used depending on the type of livestock feeding operation, the feed components being used, and the feed handling system 12 being used. The feed sources 24 may be equipped with load sensors 28, level sensors, or cameras which provide feedback to the control system 17 and allow the operator 25 to view the feed component quantities remaining and available in each feed source 24. Feed components are introduced from the feed source 24 into the feed displacement system 13 by the feed handling system 12.

The feed handling system 12 supplies a controlled introduction of a feed component from the feed source 24 to the feed displacement system 13. The extent to which the introduction of a feed component is controlled depends on the feed handling system 12 being used. For example, the feed handling system 12 may introduce a feed component into the feed displacement system 13 at a relatively constant but unknown rate. Alternatively, the feed handling system 12 may precisely meter and dose, at a predetermined rate, a feed component from the feed source 24 into the feed displacement system 13, such as with a gravimetric or volumetric ingredient feeder 27. The feed handling system 12 is generally configured for displacement of a feed and is operably connected to a source 24 of that same feed. Different systems of feed displacement used by the feed handling system 12 to introduce a feed component from the feed source 24 into the feed displacement system 13 can include belt conveyors, slat/apron conveyors, bucket conveyors, chutes, drag/chain/tow conveyors, pneumatic systems/vacuums, screws/augers, vertical conveyors, vibrating conveyors, walking conveyors, wheel conveyors, and the like.

The feed handling system 12 may include sensors or feed sampling equipment to take samples of the feed components as they are being introduced from the feed source 24 into the feed displacement system 13. In-situ analysis of the feed samples can be used to alter the feed recipe before the feeding process, in the middle of the feeding process, or later in the feeding process. For example, a sensor operably configured to the control system 17 can be used to measure, continuously or at steady intervals, the moisture or nutritional value of an individual feed source and a feed recipe. Measurements taken can be logged for record keeping using the control system 17. If it is determined that the moisture or nutritional value of the feed component is out of specification with the requirements, the recipe can be altered manually, semiautomatically, or automatically by the control system 17. For example, one or more additional feed components could be added to the recipe, or the proportions of feed components in the recipe could be adjusted to account for the offset in the feed specification. Because the quantity, position, and overall apportionment of each feed component is controlled and monitored throughout the feeding process, the automated feeding system 10 can take corrective action to rectify, adjust or otherwise increment/decrement the apportionment of any feed component.

The feed displacement system 13 receives the feed components from the feed handling system 12 at a controlled rate and displaces the feed components using a controlled feed displacer so that the quantity, position, and overall apportionment of each feed component that is received from the feed handling system 12 is known by the control system 17. The term feed displacer is used throughout and is not intended to be limiting. For example, feed displacer can include, but is not limited to, one or more conveyors such as belt conveyors, slat/apron conveyors, bucket conveyors, drag/chain/tow conveyors, screws/augers, vertical conveyors, walking conveyors, and the like. The feed displacer can also include, but is not limited to, for example, one or more elongated carriers having an open top to receive feed components, or the like. The feed displacement system 13 carries one or more of or each feed component to the feed delivery system 14 and introduces the feed components into the feed delivery system 14 at a controlled rate. Conveyors are a preferable feed displacer used by the feed displacement system 13, but in some aspects in which the feed handling system 12 is capable of introducing feed components at a precisely controlled and monitored rate, as with ingredient feeders 27, the feed components may be introduced directly into the feed delivery system 14, and thus, the feed delivery system 14 also functions as the feed displacement system 13 by traveling alongside the feed handling system 12 or using an operably connected feed displacer to receive feed components from the feed handling system 12 and displace or apportion them at a controlled rate.

The feed aggregation system 16 mixes feed components. Feed components can be introduced in a continuous flow into the feed aggregation system 16 from the feed handling system 12 or the feed displacement system 13. For example, ingredient feeders 27 can be used to meter and dose feed components directly into the feed aggregation system 16, or the feed displacement system 13 can introduce feed components to the feed aggregation system 16 at a controlled rate. Alternatively, the feed aggregation system 16 can be operably connected to the feed delivery system 14. For example, one or more mixing components may extend the full length, or at least a partial length, of the feed delivery system 14 and mix the feed components after all the feed components have been apportioned into the feed delivery system 14. In another aspect, mixing components can be operably connected to the dispensing end of the feed delivery system 14, where the feed dispensing system 15 displaces the feed components into the feed aggregation system 16 so that the feed components are mixed prior to being dispensed to the feeding area.

The feed delivery system 14 receives the apportionment of feed components from the feed displacement system 13 and transports the components to the feeding area. The feed delivery system travels alongside the feed displacement system 13 so that the feed components can be introduced from the feed displacement system 13 into the feed delivery system 14. When receiving the apportionment of feed components from the feed displacement system 13, the position of the feed delivery system 14 is controlled, such as by the control system 17, so that the feed delivery system 14 moves at the prescribed rate in relation to the rate at which the feed displacement system 13 introduces the feed components to the feed delivery system 14 to achieve a prescribed apportionment of the feed components along the length of the feed delivery system 14. Alternatively, for example, when the feed dispensing system 15 includes a conveyor extending the full, or at least a partial length, of the feed delivery system 14, and when the system configuration allows, the position of the conveyor rather than the entire feed delivery system 14 can be controlled so that the conveyor moves at the prescribed rate in relation to the rate at which the feed displacement system 13 introduces the feed components to the feed delivery system 14 to achieve a prescribed apportionment of the feed components along the length of the feed delivery system 14. The control system 17 can be configured to monitor the time and/or position-based location of each feed component in the feed displacement system 13 and feed delivery system 14. The feed delivery system 14 can be configured with an elongated carrier having an open top to receive feed components and a ground-based chassis on which the carrier is mounted. The feed delivery system 14 can be configured, for example, for travel along a track 29, but in other aspects can be configured for guided movement using GPS, radar, lidar, or a similar technology. Onboard electric, or alternatively hydraulic, pneumatic, motors are configured for moving the feed delivery system 14 along its path. The feed delivery system 14 motors can be powered by cables on reels or festoon systems or by a power rail or the like. Alternatively, the feed delivery system 14 may be powered by onboard batteries and solar power. In some aspects, the feed delivery system 14 may move by means similar to a cable car, or may be driven with a chain and sprocket, combustion engine, electrical engine, or another suitable technology. In some other aspects, the feed delivery system 14 may be propelled by stationary mounted drive wheels spaced along the track 29. The drive wheels can be powered by electric motors. For example, as the feed delivery system is in contact with a drive wheel, it is propelled by the drive wheel. The feed delivery system 14 contacts consecutive drive wheels being propelled down the track 29. Position sensors onboard the feed delivery system 14 or alongside its path 29 provide feedback to the control system 17 so that the position of the feed delivery system 14 is known and able to be controlled and monitored. The feed delivery system can also be configured as a conveyor or system of conveyors which extends from the feed displacement system 13 or the feed handling system 12 to the feeding area. In this configuration, a conveyor can extend along the length of the feeding area and feed components can be diverted from the conveyor into the feeding area, or rather the conveyor itself can be included in the bottom of a bunk from which cattle eat.

The feed dispensing system 15 dispenses the feed from the feed delivery system 14 to the feeding area. The feed dispensing system 15 in one aspect is operably connected to the feed delivery system 14 and includes a conveyor extending along the full length, or at least a partial length, of the feed delivery system 14 with a cross conveyor at one end so that the feed components may be dispensed from the feed delivery system 14 to the feeding area at a controlled rate while the feed delivery system 14 travels alongside the feeding area at a controlled rate. In operation, as the feed delivery system 14 travels along the feeding area at a controlled rate, the conveyor extending along the length of the feed delivery system 14 displaces the feed components towards the dispensing end of the feed delivery system 14 and onto the cross conveyor at a controlled rate. The feed components are discharged from the cross conveyor to the feeding area. Alternatively, in another aspect the feed dispensing system 15 may be configured for dispensing the feed components from the feed delivery system 14 in one motion. For example, a side dump system operably configured like a conventional side dump trailer can be used. A dispenser configured for rotating and emptying the feed container on the feed delivery system 14 could be operably connected to the feed delivery system 14, or the dispenser could be located alongside the feeding area track 29. In another aspect, if a conveyor or system of conveyors is used as the feed delivery system 14, the feed dispensing system 15 can comprise a conveyor belt discharge unit. For example, a one-way or two-way movable plow can be used to divert feed from the conveyor into the feeding area. Or rather, if cattle eat directly from the conveyor, no dispensing system is needed.

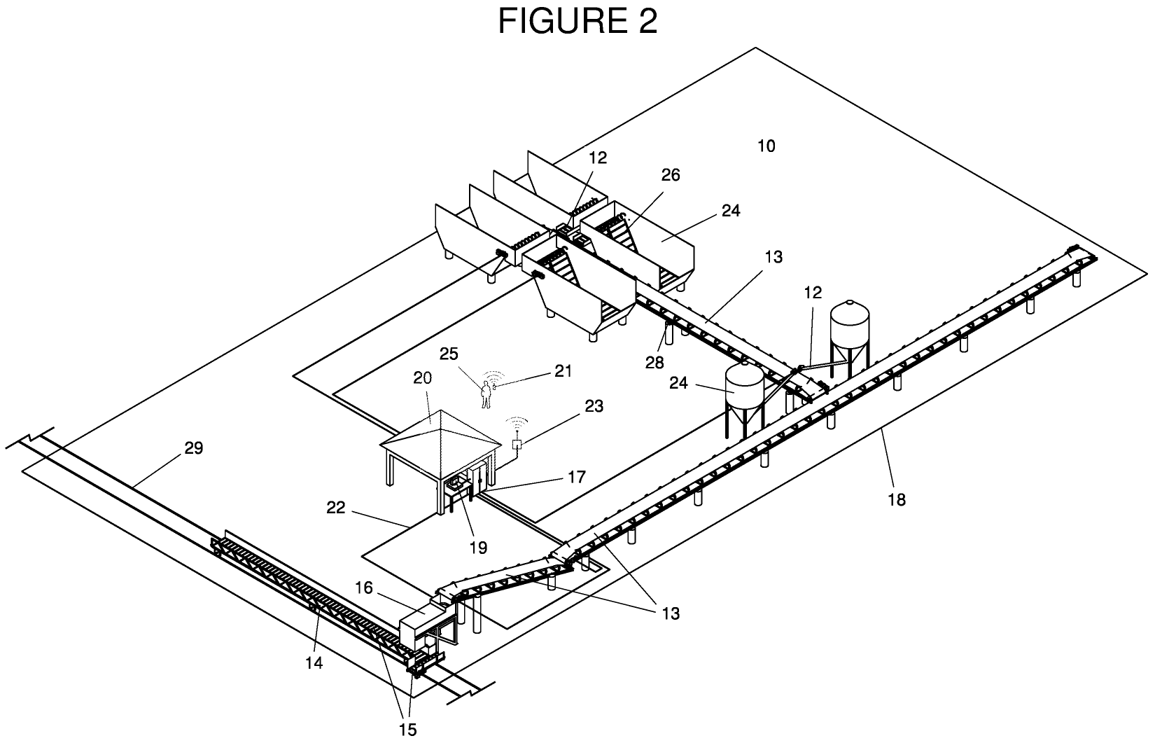

In FIG. 2, the feed components are stored in two types of feed sources 24. Feed buffer tables can be used to store different forages, silage, and other non-free-flowing feed components. Hopper bottom bins can be used to store free flowing feed components such as grains and minerals. The feed handling system 12 includes a floor conveyor 26 and a discharge cross conveyor operably connected to each buffer table, and also includes an incline auger operably connected to each hopper bottom bin. The feed displacement system 13 can include a first conveyor which is equipped with load sensors 28 and a position sensor so that the weight and position of the feed component on the conveyor is known to the control system 17. The feed displacement system 13 also can include a second and third conveyor which are equipped with position sensors so that the position of the feed components on the conveyors is known to the control system 17. The feed aggregation system 16 includes a continuous mixer with an inlet, an outlet, and a mixing chamber containing mixing components, where the flow of feed components enters the inlet, is mixed as it travels through the mixing chamber, and is discharged in a continuous flow into the feed delivery system 14. The feed delivery system 14 includes an elongated carrier having an open top to receive feed components and also includes, for example, a ground-based chassis on which the carrier is mounted. The feed delivery system 14 travels on a track 29, which guides the feed delivery system 14 to the feeding area. The feed dispensing system 15 is operably connected to the feed delivery system 14 and includes a conveyor extending the full length, or at least a partial length, of the feed delivery system 14 and a cross conveyor on one end of the feed delivery system 14 for dispensing feed to the feeding area. In operation, a single feed component is dispensed from a feed source 24 onto the first conveyor at a relatively constant but unknown rate while the conveyor displaces the feed component at a controlled rate and the weight and position of the feed component on the conveyor is tracked and monitored, for example, by the control system 17. The feed component continues to be dispensed and displaced until the prescribed weight of the feed component is measured. Once the prescribed weight of the feed component on the conveyor has been measured, the feed handling system 12 stops dispensing and the feed displacement system 13 stops displacing. At this point, the weight of the feed component and the apportionment of the feed component along the first conveyor is known, for example, by control system 17. The feed component is then reapportioned onto the second conveyor in order to achieve the prescribed apportionment of the feed component along the second conveyor. This is accomplished by controlling the position of the first conveyor in relation to the second conveyor or vice versa, such as by operable control of the control system 17 and one or more sensors. It may be noted that the first conveyor is positioned in the middle of the second conveyor, and the length of the second conveyor is considerably longer than the first conveyor. The positioning and extra length allows for the second conveyor to receive the apportionment from the first conveyor along half of its length, run in reverse motion, and reset to the same position so that another feed component can be apportioned on top of the first component along the same half length of the conveyor. Thus, the process of dispensing, weighing, tracking, and monitoring a feed component along a length of the first conveyor to achieve a known apportionment and then reapportioning the feed component to achieve a prescribed apportionment along the second conveyor is repeated for each feed component making up the feed recipe. After all feed components have been apportioned along the second conveyor, the position of the second conveyor is controlled along with the position of the third conveyor so that the apportionment of feed components along the second conveyor are carried up the third conveyor, introduced into the continuous mixer, mixed, and discharged from the continuous mixer in a continuous flow into the feed delivery system 14. The position of the feed delivery system 14 or the position of the feed dispensing system 15 conveyor extending along the length of the feed delivery system 14 is controlled, by the control system 17 for example, in relation to the position of the second and third conveyor so that the prescribed apportionment of feed components is apportioned along the prescribed length of the feed delivery system 14. The feed delivery system 14 then transports the feed to the feeding area. The feed dispensing system 15 is controlled, by the control system 17 for example, in relation to the position of the feed delivery system 14 or vice versa so that, as the feed delivery system 14 travels along the feeding area, the feed dispensing system 15 dispenses feed at the prescribed rate so that the prescribed apportionment of feed is dispensed along the feeding area. The conveyor extending along the length of the feed delivery system 14 displaces the feed towards the dispensing end of the feed delivery system 14 and onto the cross conveyor which discharges the feed to the feeding area.

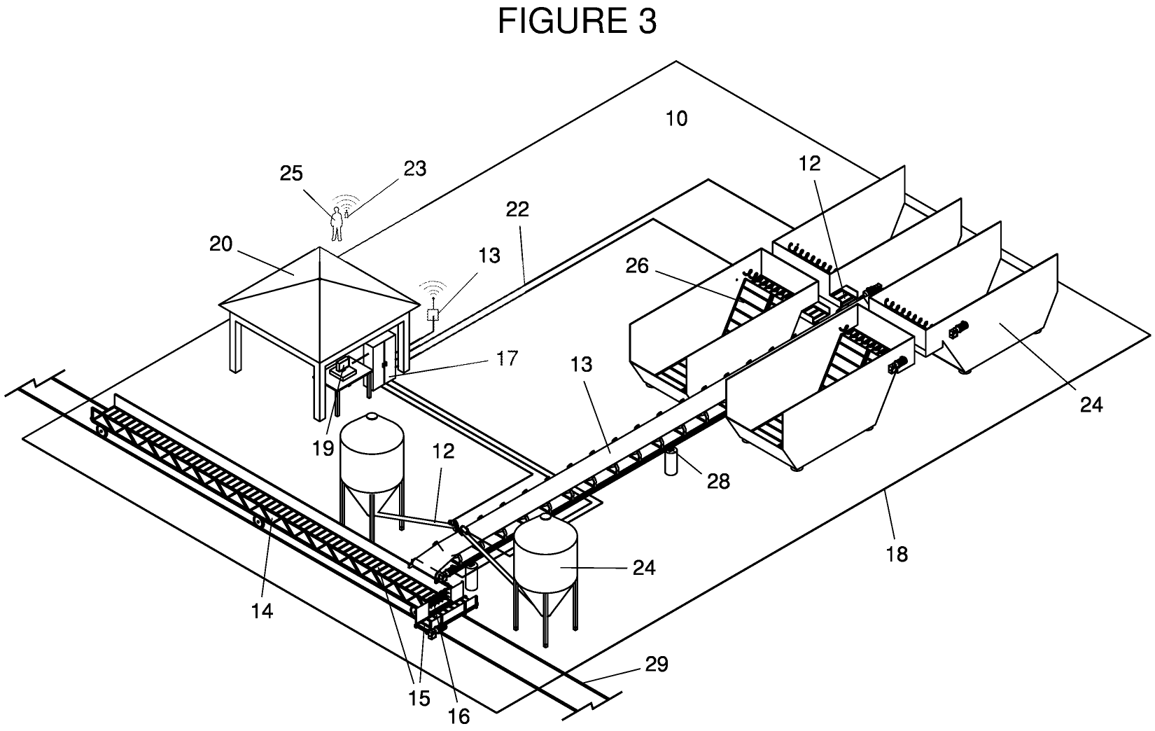

In FIG. 3, the feed components are stored in two types of feed sources 24. Feed buffer tables can be used to store different forages, silage, and other non-free-flowing feed components. Hopper bottom bins can be used to store free flowing feed components such as grains and minerals. The feed handling system 12 includes a floor conveyor 26 and a discharge cross conveyor operably connected to each buffer table, and also includes an incline auger operably connected to each hopper bottom bin. The feed displacement system 13 includes a conveyor which is equipped with load sensors 28 and a position sensor so that the weight and position of the feed component on the conveyor is known, for example, to the control system 17. The feed aggregation system 16 is operably connected to the feed delivery system 14, where the feed aggregation system 16 includes mixing components, such as rotating shafts with paddles, knives, or other processing and mixing components. The feed delivery system 14 includes an elongated carrier having an open top to receive feed components and also includes, for example, a ground-based chassis on which the carrier is mounted. The feed delivery system 14 travels on a track 29, which guides the feed delivery system 14 to the feeding area. The feed dispensing system 15 is operably connected to the feed delivery system 14 and includes a conveyor extending the full length, or at least a partial length, of the feed delivery system 14, and a cross conveyor on one end of the feed delivery system 14 for dispensing feed to the feeding area. In operation, a single feed component is dispensed from a feed source 24 onto the feed displacement system 13 conveyor at a relatively constant but unknown rate while the conveyor displaces the component at a controlled rate and the weight and position of the feed component on the conveyor is tracked and monitored, for example, by the control system 17. The feed component continues to be dispensed and displaced until the prescribed weight of the feed component is measured. Once the prescribed weight of the feed component on the conveyor has been measured, the feed handling system 12 stops dispensing and the feed displacement system 13 stops displacing. At this point, the weight of the feed component and the apportionment of the feed component along the conveyor is known, for example, by the control system 17. The feed component is then reapportioned into the feed delivery system 14 in order to achieve the prescribed apportionment of the feed component along the length of the feed delivery system 14. This is accomplished by controlling the position of the conveyor in relation to the position of the feed delivery system 14 or vice versa using the control system 17 and one or more sensors. The feed delivery system 14 travels alongside the feed displacement system 13 at a controlled rate while the feed displacement system 13 introduces the feed component into the feed delivery system 14 at a controlled rate. After a first feed component is apportioned along a length of the feed delivery system 14, the feed delivery system travels in reverse direction and resets to the same starting position so that another feed component can be apportioned on top of the first feed component along the same length of the feed delivery system 14. Thus, the process of dispensing, weighing, tracking, and monitoring a feed component along a length of the feed displacement system 13 conveyor to achieve a known apportionment and then reapportioning the feed component to achieve a prescribed apportionment along the feed delivery system 14 is repeated for each feed component making up the feed recipe. After all feed components have been apportioned along the length of the feed delivery system 14, the feed delivery system 14 then transports the feed to the feeding area. The feed dispensing system 15 is controlled, for example by the control system 17, in relation to the position of the feed delivery system 14 or vice versa so that, as the feed delivery system 14 travels along the feeding area, the feed dispensing system 15 dispenses feed at the prescribed rate so that the prescribed apportionment of feed is dispensed along the feeding area. The conveyor extending along the length of the feed delivery system 14 displaces the feed towards the dispensing end of the feed delivery system 14. Before the feed components are dispensed onto the cross conveyor of the feed dispensing system 15, they pass through the feed aggregation system 16 which blends the feed components using a series of mixing components. Thus, the feed components are mixed as they are dispensed from the feed dispensing system 15 to the feeding area.

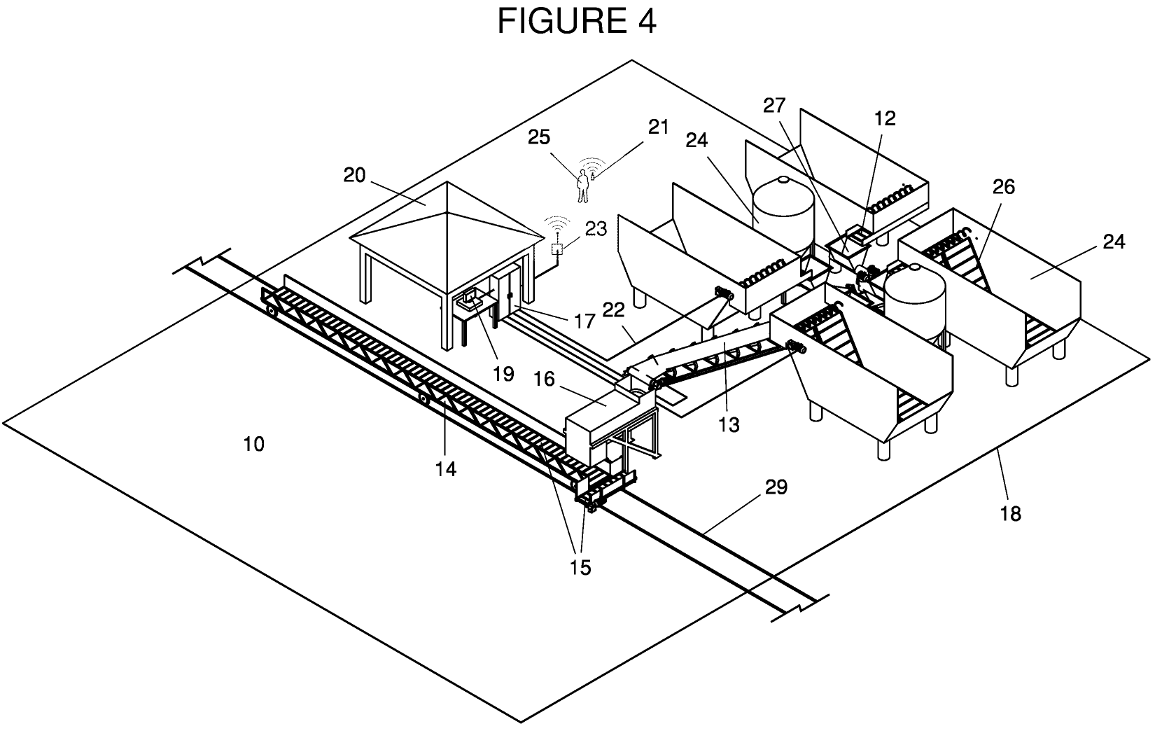

In FIG. 4, the feed components are stored in two types of feed sources 24. Feed buffer tables can be used to store different forages, silage, and other non-free-flowing feed components. Hopper bottom bins can be used to store free flowing feed components such as grains and minerals. The feed handling system 12 includes a floor conveyor 26 and a discharge cross conveyor operably connected to each buffer table along with an ingredient feeder 27, and also includes an ingredient feeder 27 operably connected to each hopper bottom bin. The feed displacement system 13 includes a conveyor which is equipped with a position sensor so position of the feed component on the conveyor is known, such as to the control system 17. The feed aggregation system 16 includes a continuous mixer with an inlet, an outlet, and a mixing chamber containing mixing components, where the flow of feed components enters the inlet, is mixed as it travels through the mixing chamber, and is discharged in a continuous flow. The feed delivery system 14 includes an elongated carrier having an open top to receive feed components and includes a ground-based chassis on which the carrier is mounted. The feed delivery system 14 travels, for example, on a track 29, which guides the feed delivery system 14 to the feeding area. The feed dispensing system 15 is operably connected to the feed delivery system 14 and includes a conveyor extending the full length, or at least a partial length, of the feed delivery system 14 and a cross conveyor on one end of the feed delivery system 14 for dispensing feed to the feeding area. In operation, feed components are metered and dosed from ingredient feeders 27 onto the feed displacement system 13 conveyor at predetermined rates according to the recipe using gravimetric or volumetric ingredient feeders 27. The feed components can be carried up the feed displacement system 13 conveyor and introduced into the feed aggregation system 16 continuous mixer and discharged from the continuous mixer in a continuous flow into the feed delivery system 14. The position of the feed delivery system 14 or the position of the feed dispensing system 15 extending along the length of the feed delivery system 14 is controlled, by the control system 17 for example, in relation to the rates at which the ingredient feeders 27 are dosing the feed components and the feed displacement system 13 is displacing the feed components so that the prescribed apportionment of feed components is apportioned along the length of the feed delivery system 14. The feed delivery system 14 then transports the feed to the feeding area. The feed dispensing system 15 is controlled, by the control system 17 for example, in relation to the position of the feed delivery system 14 or vice versa so that, as the feed delivery system 14 travels along the feeding area, the feed dispensing system 15 dispenses feed at the prescribed rate so that the prescribed apportionment of feed is dispensed along the feeding area. The conveyor extending along the length of the feed delivery system 14 displaces the feed towards the dispensing end of the feed delivery system 14 and onto the cross conveyor which discharges the feed to the feeding area.

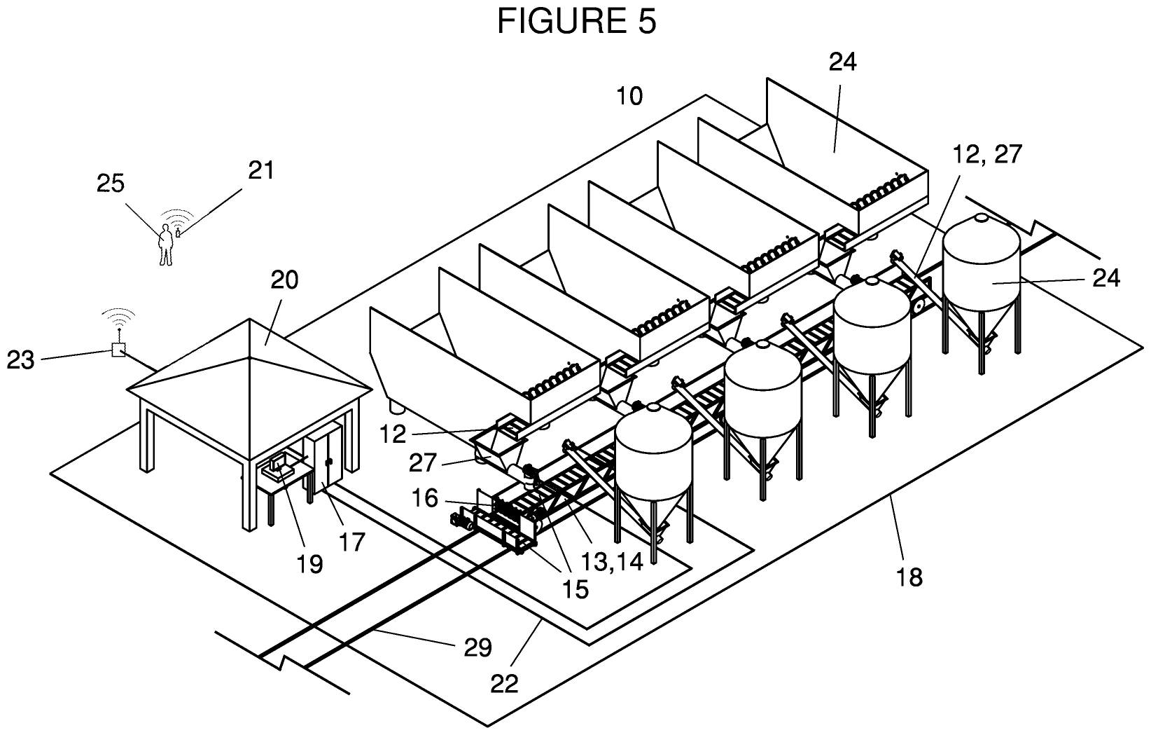

In FIG. 5, the feed components are stored in two types of feed sources 24. Feed buffer tables can be used to store different forages, silage, and other non-free-flowing feed components. Hopper bottom bins can be used to store free flowing feed components such as grains and minerals. The feed handling system 12 includes a floor conveyor and a discharge cross conveyor operably connected to each buffer table along with an ingredient feeder 27, and also includes an ingredient feeder 27 operably connected to each hopper bottom bin. The delivery system 14 functions as the feed displacement system 13 such that it directly receives each feed component from the feed handling system 12. The feed aggregation system 16 is operably connected to the feed delivery system 14, where the feed aggregation system 16 includes mixing components such as rotating shafts with paddles, knives, or other processing and mixing components. The feed delivery system 14 includes an elongated carrier having an open top to receive feed components and includes a ground-based chassis on which the carrier is mounted. The feed delivery system 14 travels, for example, on a track 29, which guides the feed delivery system 14 to the feeding area. The feed dispensing system 15 is operably connected to the feed delivery system 14 and includes a conveyor extending the full length, or at least a partial length, of the feed delivery system 14 and a cross conveyor on one end of the feed delivery system 14 for dispensing feed to the feeding area. In operation, a single feed component is metered and dosed from an ingredient feeder 27 directly into the feed delivery system 14 at a predetermined, precisely controlled rate according to the recipe while the feed delivery system 14 travels underneath the ingredient feeder 27 at a controlled rate receiving the feed component. The position of the feed delivery system 14 is controlled in relation to the rate at which the ingredient feeder 27 meters and doses the feed component so that the prescribed apportionment of the feed component is apportioned along the prescribed length of the feed delivery system 14. After a first feed component is apportioned along a length of the feed delivery system 14, the feed delivery system 14 travels to the second ingredient feeder 27 and resets to the same starting position so that another feed component can be apportioned on top of the first feed component along the same length of the feed delivery system 14. The process of metering and dosing a single feed component at a precisely controlled rate from an ingredient feeder 27 directly into the feed delivery system 14 while the feed delivery system 14 travels beneath the ingredient feeder 27 at a controlled rate is repeated, such as by operation of the control system 17, until all feed components have been inserted into the feed delivery system 14. The feed delivery system 14 then transports the feed to the feeding area. The feed dispensing system 15 is controlled, by the control system 17 for example, in relation to the position of the feed delivery system 14 or vice versa, so that, as the feed delivery system 14 travels along the feeding area, the feed dispensing system 15 dispenses feed at the prescribed rate so that the prescribed apportionment of feed is dispensed along the feeding area. Before the feed components are dispensed onto the cross conveyor, they pass through the feed aggregation system 16 which blends the feed components using a series of mixing components. Thus, the feed components are mixed as they are discharged from the feed dispensing system 15 to the feeding area.

The figures and description provide disclosure of a feed delivery system 14 for feeding livestock. The feed delivery system 14 can be configured to include a plurality of feed sources 24. Each feed source 24 is operably configured for housing a feed component. A plurality of feed sources 24 house a plurality of feed components. Feed components can include, but are not limited to, forages, grains, proteins, supplements, byproducts, vitamins, minerals, and sometimes medicated feed additives. Feed components are apportioned from the feed sources 24 for preparing a prescribed apportionment of two or more of the plurality of feed components for feeding livestock. The feed displacement system 13 can be configured as an elongated feed carrier. The elongated feed carrier can be positioned within the automated feeding system 10 proximate the plurality of feed sources 24 to receive the two or more of the plurality of feed components from the feed sources 24. The computer 19 having a controller or be operably configured to control one or more controllers, or independently one or more programmable logic controllers (PLC) may be configured, to control the introduction of the two or more of the plurality of feed components to the elongated feed carrier from the feed sources 24. A position of two or more of the plurality of feed components along the elongated feed carrier can be controlled by the computer 19, a controller operable by the computer 19, or one or more PLC's to provide a prescribed apportionment of the two or more of the plurality of feed components for feeding livestock. The feed displacement system 13 can include a feed displacer such as a means of displacement operably configured along a length of the elongated feed carrier. The means of displacement of the feed displacement system 13 can include for example, but is not limited to, belt conveyors, slat/apron conveyors, bucket conveyors, chutes, drag/chain/tow conveyors, pneumatic systems/vacuums, screws/augers, vertical conveyors, vibrating conveyors, walking conveyors, wheel conveyors, and other suitable means of displacement. A position of the means of displacement can be controlled by the computer 19, a controller operable by the computer 19, or one or more PLC's for controlling the position of the two or more of the plurality of feed components to provide the prescribed apportionment of the two or more of the plurality of feed components. In at least one aspect, the two or more of the plurality of feed components are apportionable along the means of displacement of the feed displacement system 13 or dispensed by the means of displacement of the feed displacement system 13 by controlling a position of the means of displacement during introduction of the plurality of feed components from the feed sources 24. In at least one other aspect, the feed displacement system 13 can be configured with a means of displacement operably configured and disposed at least along a portion of a length of the elongated feed carrier. The feed displacement system 13 can also be configured whereby a position of the means of displacement is operably controlled by the computer 19, a controller operable by the computer 19, or one or more PLC's for providing the prescribed apportionment of the two or more of the plurality of feed components along the portion of the length of the elongated feed carrier or for dispensing the two or more of the plurality of feed components. In at least still one other aspect, the feed displacement system 13 can be configured whereby the means of displacement is operably configured and disposed at least along a portion of a length of the elongated feed carrier and a position of the means of displacement may be controlled by the computer 19, a controller operable by the computer 19, or one or more PLC's to provide the prescribed apportionment of the two or more of the plurality of feed components. The feed delivery system 10 is preferably configured within a feeding area for feeding livestock whereby the elongated feed carrier is also operably positioned proximate the livestock feeding area. In yet another aspect of the feed delivery system 10, the means of displacement of the feed displacement system 13 may be operably configured and disposed at least along a portion of a length of the elongated feed carrier such that the prescribed apportionment of two or more of the plurality of feed components is distributed along the livestock feeding area by displacing the prescribed apportionment of the two or more of the plurality of feed components from the elongated feed carrier of the feed displacement system 13 at a controlled rate with using means of displacement. In another aspect, the feed delivery system 10 is configured within the feeding area for feeding livestock whereby the elongated feed carrier of the feed displacement system 13 is located proximate the livestock feeding area such that the prescribed apportionment of the two or more of the plurality of feed components is distributed along the feeding area by transferring the prescribed apportionment of the two or more of the plurality of feed components from elongated feed carrier to the feeding area for feeding livestock.

The feed delivery system 10 can also be configured to include one or more sensors 28. Sensors and analysis of sensor readings may include, but are not limited to, load/weight inspection and analysis, volume inspection and analysis, optical via video and still image inspection and analysis, spectral inspection and analysis via a spectrometer, density inspection and analysis via detection of reflected and/or absorbed light and/or sound waves, and other suitable sensors and analysis of sensor readings. The one or more sensors 28 may be operably controlled by the computer 19, a controller operable by the computer 19, or one or more PLC's. The one or more sensors 28 can be operably configured to detect one or more properties of the plurality of feed components from the feed sources 24. A data store may be operably configured to receive sensor data from a sensor 28 for recording one or more properties of the plurality of feed components from the feed sources 24. The data store can be operably controlled by the computer 19, a controller operable by the computer 19, or one or more PLC's. The sensor 28 may operably configured to make a detection of one or more properties of the prescribed apportionment of two or more of the plurality of feed components by in-situ analysis. In at least one aspect of the feed delivery system 10, the means of displacement of the feed displacement system 13 may be operably configured and disposed at least along a portion of a length of the elongated feed carrier whereby operation of the means of displacement and introduction of the plurality of feed components from feed sources 24 using the computer 19, a controller operable by the computer 19, or one or more PLC's is based at least in part on the detection of the one or more properties of the prescribed apportionment of two or more of the plurality of feed components using one or more sensors 28.

In a preferred aspect of the present disclosure, the feed delivery system 10 is configured to provide a controlled apportionment of feed ingredients along the means of displacement to be at some point be fed into feed aggregation system 16 and/or distributed to a feeding area in a controlled manner using a computer 19, a controller operable by the computer 19, or one or more PLC's. Thus, the feed delivery system 10 provides for optimizing the delivery of feed components to each animal in a group in a defined and consistent manner.

In a preferred aspect of the present disclosure, the feed delivery system 10 is configured having a feed carrier whereby the means of displacement of the feed displacement system 13 extends the full, or at least partial length, of the feed delivery system 10 whereby a desired distribution of feed can be achieved along a feeding area by controlling the rate of the means of displacement extending along the feed delivery system 10 in relation to the rate of travel along the feeding area. Thus, the delivery of feed to a feeding area is ultimately governed by position of feed components rather than, for example, weighing feed components to determine and/or achieve a prescribed apportionment of two or more of the plurality of feed components from the elongated feed carrier of the feed displacement system 13.

What is claimed is:

1. A feed component apportionment system for feeding livestock, comprising:
a plurality of feed sources, each of the plurality of feed sources operatively configured for dispensing one or more of a plurality of feed components during a dispensing operation;
at least one feed handling system for receiving one or more of the plurality of feed components from each of the plurality of feed sources and moving the plurality of feed components using one or more feed displacers, wherein the feed handling system is operatively configured to apportion each of the plurality of feed components along at least one of the one or more feed displacers during a feed handling operation;
at least one feed component aggregator operatively configured to receive each of the plurality of feed components from the plurality of feed sources and provide an aggregated output of the plurality of feed sources during a feed component aggregator operation; and
at least one controller operatively configured to control the dispensing operation, the feed handling operation, and the feed component aggregator operation;
wherein the plurality of feed components are apportioned on at least one of the one or more feed displacers before the feed component aggregator operation.

2. The feed component apportionment system of claim 1, wherein one or more of the plurality of feed components are dispensed concurrently onto at least one of the feed displacers during the feed handling operation.

3. The feed component apportionment system of claim 1, wherein one or more of the plurality of feed components are dispensed consecutively onto at least one of the feed displacers during the feed handling operation.

4. The feed component apportionment system of claim 1, wherein the feed handling operation includes advancing at least one of the feed displacers in a first direction and an opposite second direction during the dispensing operation for apportionment of the plurality of feed components.

5. The feed component apportionment system of claim 1, wherein a location and a quantity of the plurality of feed components is tracked with the at least one controller during the feed handling operation for determining apportionment of the plurality of feed components for the feed component aggregator operation.

6. The feed component apportionment system of claim 1, wherein one or more feed displacers of the feed handling system are shuttled relative to the plurality of feed sources.

7. The feed component apportionment system of claim 1, wherein one or more feed displacers of the feed handling system are shuttled relative to the feed component aggregator operation.

8. A method for automated apportionment of feed components for creating a feed recipe for feeding livestock, comprising:
providing a plurality of feed sources, at least one feed handling system having one or more feed displacers, at least one feed component aggregator, and at least one controller;
dispensing one or more of a plurality of feed components from the plurality of feed sources during a dispensing operation;
apportioning on at least one feed displacer each of the plurality of feed components from the plurality of feed sources during a feed handling operation;
receiving the apportioned plurality of feed components at the at least one feed component aggregator;
aggregating the plurality of feed sources into an aggregated output of the plurality of feed sources during a feed component aggregator operation;
dispensing the aggregated output of the plurality of feed sources to a feeding area; and
controlling the dispensing operation, the feed handling operation, and the feed component aggregator operation with the controller for automated apportionment of the plurality of feed components for creating the feed recipe for feeding livestock.

9. The method of claim 8, further comprising:
dispensing one or more of the plurality of feed components concurrently onto at least one of the feed displacers during the feed handling operation; or
dispensing one or more of the plurality of feed components consecutively onto at least one of the feed displacers during the feed handling operation.

10. The method of claim 8, further comprising:
tracking location and quantity of the plurality of feed components with the at least one controller during the feed handling operation for determining apportionment of the plurality of feed components for the feed component aggregator operation.

11. The method of claim 8, wherein the feed handling operation includes advancing at least one of the feed displacers in a first direction and an opposite second direction during the dispensing operation for apportionment of the plurality of feed components.

12. The method of claim 8, further comprising:
shuttling one or more feed displacers of the feed handling system relative to the plurality of feed sources; or
shuttling one or more feed displacers of the feed handling system relative to the feed component aggregator operation.

13. A feed delivery system for livestock, comprising:
a plurality of feed sources configured for housing a plurality of feed components for preparing a prescribed apportionment of two or more of the plurality of feed components for feeding livestock;
an elongated feed carrier operably configured and disposed proximate the plurality of feed sources to receive the two or more of the plurality of feed components;
a controller operably configured to control the elongated feed carrier and introduction of the two or more of the plurality of feed components to the elongated feed carrier; and
a position of the two or more of the plurality of feed components along the elongated feed carrier being controlled by the controller to provide the prescribed apportionment of the two or more of the plurality of feed components for feeding livestock.

14. The feed delivery system of claim 13, further comprising:
a means of displacement operably configured along a length of the elongated feed carrier; and
a position of the means of displacement being operably controlled by the controller for controlling the position of the two or more of the plurality of feed components to provide the prescribed apportionment of the two or more of the plurality of feed components.

15. The feed delivery system of claim 13, wherein the two or more of the plurality of feed components are apportionable along a means of displacement or dispensed by the means of displacement by controlling a position of the means of displacement during introduction of the plurality of feed components.

16. The feed delivery system of claim 13, further comprising
a means of displacement operably configured and disposed at least along a portion of a length of the elongated feed carrier; and
a position of the means of displacement operably controlled by the controller for providing the prescribed apportionment of the two or more of the plurality of feed components along the portion of the length of the elongated feed carrier or for dispensing the two or more of the plurality of feed components.

17. The feed delivery system of claim 13, further comprising:
a means of displacement operably configured and disposed at least along a portion of a length of the elongated feed carrier; and
a position of the means of displacement controlled by the controller to provide the prescribed apportionment of the two or more of the plurality of feed components.

18. The feed delivery system of claim 13, further comprising:
a feeding area for feeding livestock located proximate the elongated feed carrier; and
a means of displacement operably configured and disposed at least along a portion of a length of the elongated feed carrier;
wherein the prescribed apportionment of the two or more of the plurality of feed components is distributed along the feeding area by displacing the prescribed apportionment of the two or more of the plurality of feed components from the elongated feed carrier at a controlled rate with the means of displacement.

19. The feed delivery system of claim 13, further comprising:
a feeding area for feeding livestock located proximate the elongated feed carrier; and
wherein the prescribed apportionment of the two or more of the plurality of feed components is distributed along the feeding area by transferring the prescribed apportionment of the two or more of the plurality of feed components from elongated feed carrier to the feeding area for feeding livestock.

20. The feed delivery system of claim 13, further comprising:
a sensor operably configured to detect one or more properties of the plurality of feed components; and
a data store operably configured to receive sensor data from the sensor for recording the one or more properties of the plurality of feed components.

21. The feed delivery system of claim 13, further comprising:
a sensor operably configured to make a detection of one or more properties of the prescribed apportionment of the two or more of the plurality of feed components by in-situ analysis;
a means of displacement operably configured and disposed at least along a portion of a length of the elongated feed carrier;
wherein operation of the means of displacement and introduction of the plurality of feed components by the controller is based at least in part on the detection of the one or more properties of the prescribed apportionment of the two or more of the plurality of feed components.
